(19) United States
(12) Patent Application Publication
(10) Pub. No.: US 2003/0081435 A1
(43) Pub. Date: May 1, 2003

(54) Auxiliary on chip voltage generation

(76) Inventor: Paul P. Chominski, San Diego, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/016,580

(22) Filed: Nov. 1, 2001

(51) Int. Cl. H02M 3/18

(52) U.S. Cl. 363/61

(57) ABSTRACT

A power supply which supplies negative or additional voltages in addition to the normal IC bias voltage is efficient in terms of cost, “real estate” required on a silicon chip and effective in operation. A random noise source provides an input which is rectified and can provide a negative voltage for GaAs FETs provide additional to bias a tuning component. The voltage may be used for other requirements on the integrated circuit chip as well.

### FIELD OF INVENTION

The present invention relates to generating voltage on an integrated circuit chip which voltage is in addition to chip supply voltage.

### BACKGROUND OF THE INVENTION

Integrated circuits on chips are designed to form selected functions. To this end, particular circuits are placed on the chip. A common part of chip design is providing a bias voltage from which the circuits on the chip will be supplied. The entire classes of chips are known by their voltage supply, e.g. 5 volt logic or 2.8 volt logic.

However, some chips need a voltage supply that cannot be accommodated by the standard positive voltage provided for by an IC (integrated circuit) power supply. For example, the whole family of GaAs FET (galium arsenide field effect transistor)family of integrated circuits requires a negative voltage supply. This applies to GaAs FET switches, attenuators, amplifiers and power amplifiers. One common way of accommodating this requirement is to provide a negative bias voltage. However, providing a negative bias voltage requires a higher count of external components, i.e. those components not in the GaAs FET circuit. The higher the parts count, the more space the circuit must take up on its silicon substrate. This increases size and expense of an integrated circuit chip. Parts count also requires further circuit runs, each of which is a potential source of noise, distortion or signal attenuation.

In communications, voltages are required for tuning circuits such as oscillators, filters and phase shifters. The standard chip supply voltage can provide for only a fixed range of tuning variation on the components having their input voltage vary. A common tuning component which must be supplied with a voltage is a tuning, or Varactor, diode. It is highly desirable to increase the range of tuning available by increasing available tuning voltage and to do it without the need for additional external components. Common solutions to provide additional voltage to a chip include the use of square wave generators or switching capacitor techniques. A recent approach gaining in popularity to supply negative voltage to a GaAs FET circuit is the charge pump IC. The charge pump is a DC-DC voltage converter that uses capacitors rather than inductors or transformers to store and transfer energy. The charge pump may have a switching frequency of 100 kHz. In addition, a regulator must normally be used at the output of the charge pump.

It is also possible to use fewer additional components in order to generate negative bias on an IC. One technique is using virtual ground at the level of the IC supply, for example, five volts. Virtual ground techniques degrade performance of the devices. Some GaAs FET amplifiers are produced using MMIC (monolithic microwave integrated circuit) technology providing internal bias in the form of a voltage source in the drain circuit of the FETs. This serves to provide the voltage requirement but increases the noise figure and decreases the maximum operational frequency and stability before the amplifier and will begin self-oscillation.

One reason it is important to provide an efficient solution is that GaAs FET power amplifiers are used in hand-held telephones. It is desirable to produce these phones as cost effectively as possible.

### SUMMARY OF THE INVENTION

In accordance with the present invention, a power supply which supplies negative or additional voltages in addition to the normal IC bias voltage is provided which is efficient in terms of cost, “real estate” required on a silicon chip and effective in operation. Briefly stated, in accordance with the present invention, a random noise source provides an input which is rectified and can provide a negative voltage for GaAs FETs provide additional to bias a tuning component. The voltage may be used for other requirements on the integrated circuit chip as well.

### BRIEF DESCRIPTION OF THE DRAWINGS

The invention is described by way of example, the following description taken in connection with the following drawings:

Of the drawings:

FIG. 1a is a schematic diagram of a voltage source constructed in accordance with the present invention;

FIG. 1b is a waveform chart of voltage versus time waveforms appearing at correspondingly labeled locations of FIG. 1a;

FIG. 2 is a further embodiment of the invention including multiple rectifiers for applications having low current requirements and higher voltage requirements; and

FIG. 3 illustrates an example in which the voltage source provides an additional voltage to the integrated circuit.

### DETAILED DESCRIPTION OF THE INVENTION

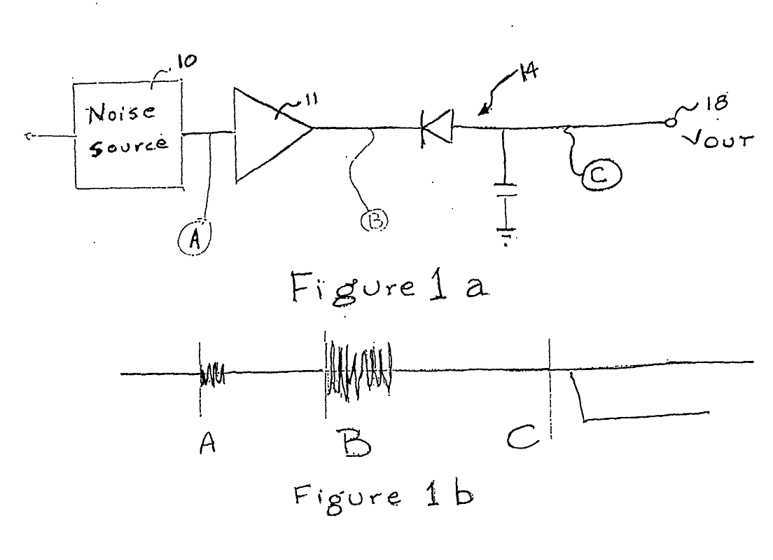

FIG. 1a represents an integrated circuit chip auxiliary voltage supply 1. The supply 1 includes a noise source 10 providing an input to an amplifier 11. The amplifier 11 delivers an output to a rectifier 14 comprising a diode 15 connected to supply a negative voltage output and a capacitor 16 connected between an output terminal 18 and ground. The noise source 10 preferably comprises a wide-band amplifier. Noise is present at many terminals in a circuit. The noise source 10 could comprise transistor amplifier outputs, load resistors active component terminal, among other possibilities.

Nominal values for the wide-band amplifier include:

noise factor, NF=10 dB

Gain=74 dB

Bandwidth BW=1 GHz.

In this example, noise power Pn=0 dBm. The peak detector 11 has a load resistance of R1=1 kohm, and will generate 1.41 volts. More generally stated, the power at the detector 11 will be: (1) Pdet dbm=kTb+FG+BW−174+10+74+90=0 dBm. kTB is derived from the Nyquist Theorem for electron thermal noise temperature in degrees K and B is measurement IF bandwidth in Hz. At room temperature, kTB=−174 dBm/Hz.

BW(dBM)=10 log BW(Hz)=10 log 1,000,000,000=90

(2) Vdet+SQRT (P*R det)=1 V rms=1.41 Vp

Noise power density at the detector input is low, Pndet=−90 [Hz].

FIG. 1b is a waveform chart of signals at points labeled A, B and C in FIG. 1a. At point A, noise at the output of the noise source 10 is illustrated. The signal at A is amplified as represented by the output of the amplifier 11 at point B. The rectifier 14 provides half-wave rectification in the embodiment of FIG. 1a. The rectifier 14 is polarized to provide a negative output. Consequently, a negative, substantially directed current voltage is provided at point C.

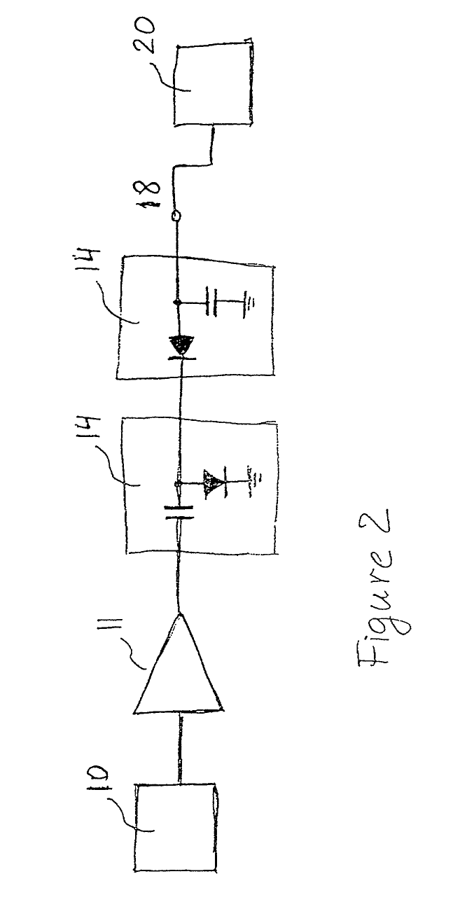

FIG. 2 illustrates a further embodiment of the application in which low current and a higher voltage is required. In this case, two rectifiers 14 are provided at the output of the detector 11. The rectifiers 14 provide voltage doubling. Load devices 20 are coupled to the input terminal 18.

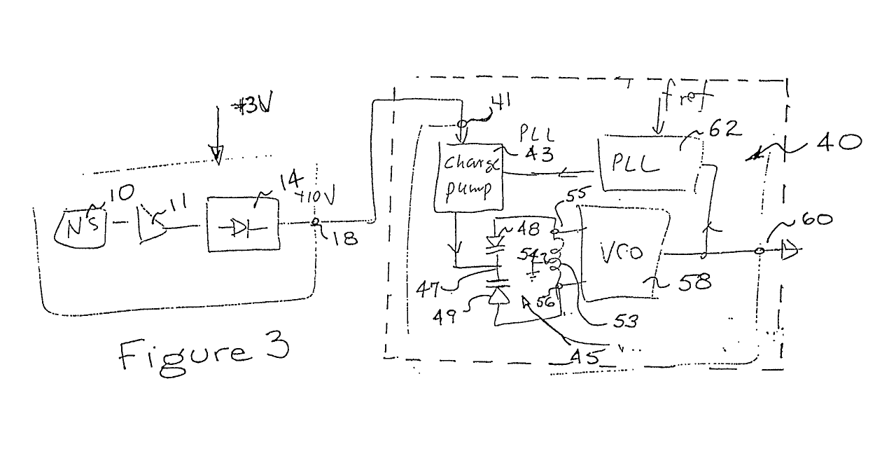

FIG. 3 is a schematic diagram of a system demonstrating operation of the present invention. In this embodiment, the rectifier 14 is polarized to produce a positive voltage output. The embodiment of FIG. 3 comprises an integrated circuit chip using three volt logic. One or more rectifiers 14 are connected in series to supply a phase locked loop 40.

The phase locked loop 40 has an input terminal 41 coupled to a charge pump 43. The terminal 41 is coupled to the output terminal 18. The charge pump 43 supplies a tuning voltage Vₜᵤₙₑ. Vₜᵤₙₑ is coupled to a tuning circuit 45 at a terminal 47 intermediate cathodes of Varactor diodes 48 and 49. The oppositely connected Varactor diodes are connected across a tuning coil 54 having a grounded center tap 5. Terminals 55 and 56 at either end of the coil 53 comprise inputs to a voltage controlled oscillator (VCO) 58, supplying an output frequency at a terminal 60.

The VCO 58 also provides an input to error circuit 62. The error circuit 62 compares the frequency F to a reference signal having a frequency F_{ref}, and provides an error signal to the charge pump 43.

The additional voltage supplied to the charge pump 43 increases the tuning range of the tuning circuit 45 and linearity. An increased value of Vₜᵤₙₑ also decreases noise close to zero value of tuning voltage. Consequently improved operation of the phase locked loop 40 is provided.

The above description has been written with a view toward enabling those skilled in the art to make many departures from the specific examples shown above while

The above description has been written with a view toward enabling those skilled in the art to make many departures from the specific examples shown above while providing an IC power supply which can supply a solid state circuit or be included on a chip and which, in the alternative could be provided in a separate IC for coupling with an IC including operating circuitry and a conventional source of bias.

What is claimed is:

1. A power supply for use with a solid state circuit comprising:
a noise source, a detector receiving input from said noise source, and a rectifier rectifying the output of said detector and providing a voltage at an output terminal for supply to the integrated circuit.

2. The voltage supply according to claim 1 wherein said rectifier comprises a voltage multiplying rectifier.

3. The voltage supply according to claim 1 wherein said noise source comprises an amplifier.

4. The voltage supply according to claim 1 wherein said rectifier is polarized to provide a negative output.

5. The voltage supply according to claim 3 wherein said rectifier is polarized to provide a negative output.

6. The voltage supply according to claim 1 wherein said power supply and said solid state circuit are comprised in an integrated circuit chip.

7. An integrated circuit chip comprising:
an integrated circuit, a bias supply and an additional voltage source for providing a voltage, said additional voltage source comprising a noise source, a detector receiving input from said noise source, and a rectifier rectifying the output of said detector and providing a voltage at an output terminal to comprise a voltage supply in the integrated circuit.

8. The integrated circuit chip of claim 6 wherein the rectifier is polarized to provide a positive output.

9. The integrated circuit chip of claim 6 wherein the rectifier is polarized to provide a negative output.

10. The integrated circuit chip of claim 6 wherein said rectifier comprises a voltage multiplying rectifier.
